(19) United States
(12) Patent Application Publication
(10) Pub. No.: US 2026/0113651 A1
(43) Pub. Date: Apr. 23, 2026

(54) TRANSMISSIVE SURFACE IDENTIFICATION

(71) Applicant: QUALCOMM Incorporated, San Diego, CA (US)

(72) Inventors: Narayan PRASAD, Westfield, NJ (US); Tao LUO, San Diego, CA (US); Junyi LI, Greentown, PA (US); Jorge FABREGA SANCHEZ, San Diego, CA (US); Allen Minh-Triet TRAN, Rancho Santa Fe, CA (US)

(21) Appl. No.: 18/919,055

(22) Filed: Oct. 17, 2024

(51) Int. Cl. H04W 24/10; H04L 5/00

(52) U.S. Cl. CPC H04W 24/10; H04L 5/005

(57) ABSTRACT

Various aspects of the present disclosure generally relate to wireless communication. In some aspects, a user equipment (UE) may receive transmissive surface information via a data marker. The UE may receive a downlink signal via a transmissive surface associated with the transmissive surface information. The UE may transmit a measurement report associated with the downlink signal received via the transmissive surface, wherein the transmissive surface information includes one or more of: a transmissive surface location, attribute information associated with the transmissive surface, one or more synchronization signal block (SSB) parameters, or SSB beam information. Numerous other aspects are described.

### FIELD OF THE DISCLOSURE

Aspects of the present disclosure generally relate to wireless communication and specifically relate to techniques, apparatuses, and methods associated with identifying a transmissive surface.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a user equipment (UE) for wireless communication. The UE may include one or more memories and one or more processors coupled to the one or more memories. The one or more processors may be configured to receive transmissive surface information via a data marker. The one or more processors may be configured to receive a downlink signal via a transmissive surface associated with the transmissive surface information. The one or more processors may be configured to transmit a measurement report associated with the downlink signal received via the transmissive surface, where the transmissive surface information includes one or more of: a transmissive surface location, attribute information associated with the transmissive surface, one or more synchronization signal block (SSB) parameters, or SSB beam information.

Some aspects described herein relate to a network node for wireless communication. The network node may include one or more memories and one or more processors coupled to the one or more memories. The one or more processors may be configured to output, for a UE, a downlink signal via a transmissive surface associated with transmissive surface information available via a data marker. The one or more processors may be configured to receive, from the UE, a measurement report associated with the downlink signal. The one or more processors may be configured to update the transmissive surface information in accordance with the measurement report, where the transmissive surface information includes one or more of: a transmissive surface location, attribute information associated with the transmissive surface, one or more SSB parameters, or SSB beam information.

Some aspects described herein relate to a method of wireless communication performed by a UE. The method may include receiving transmissive surface information via a data marker. The method may include receiving a downlink signal via a transmissive surface associated with the transmissive surface information. The method may include transmitting a measurement report associated with the downlink signal received via the transmissive surface, where the transmissive surface information includes one or more of: a transmissive surface location, attribute information associated with the transmissive surface, one or more SSB parameters, or SSB beam information.

Some aspects described herein relate to a method of wireless communication performed by a network node. The method may include outputting, for a UE, a downlink signal via a transmissive surface associated with transmissive surface information available via a data marker. The method may include receiving, from the UE, a measurement report associated with the downlink signal. The method may include updating the transmissive surface information in accordance with the measurement report, where the transmissive surface information includes one or more of: a transmissive surface location, attribute information associated with the transmissive surface, one or more SSB parameters, or SSB beam information.

Some aspects described herein relate to a non-transitory computer-readable medium that stores a set of instructions for wireless communication by a UE. The set of instructions, when executed by one or more processors of the UE, may cause the UE to receive transmissive surface information via a data marker. The set of instructions, when executed by one or more processors of the UE, may cause the UE to receive a downlink signal via a transmissive surface associated with the transmissive surface information. The set of instructions, when executed by one or more processors of the UE, may cause the UE to transmit a measurement report associated with the downlink signal received via the transmissive surface, where the transmissive surface information includes one or more of: a transmissive surface location, attribute information associated with the transmissive surface, one or more SSB parameters, or SSB beam information.

Some aspects described herein relate to a non-transitory computer-readable medium that stores a set of instructions for wireless communication by a network node. The set of instructions, when executed by one or more processors of the network node, may cause the network node to output, for a UE, a downlink signal via a transmissive surface associated with transmissive surface information available via a data marker. The set of instructions, when executed by one or more processors of the network node, may cause the network node to receive, from the UE, a measurement report associated with the downlink signal. The set of instructions, when executed by one or more processors of the network node, may cause the network node to update the transmissive surface information in accordance with the measurement report, where the transmissive surface information includes one or more of: a transmissive surface location, attribute information associated with the transmissive surface, one or more SSB parameters, or SSB beam information.

Some aspects described herein relate to an apparatus for wireless communication. The apparatus may include means for receiving transmissive surface information via a data marker. The apparatus may include means for receiving a downlink signal via a transmissive surface associated with the transmissive surface information. The apparatus may include means for transmitting a measurement report associated with the downlink signal received via the transmissive surface, where the transmissive surface information includes one or more of: a transmissive surface location, attribute information associated with the transmissive surface, one or more SSB parameters, or SSB beam information.

Some aspects described herein relate to an apparatus for wireless communication. The apparatus may include means for outputting, for a UE, a downlink signal via a transmissive surface associated with transmissive surface information available via a data marker. The apparatus may include means for receiving, from the UE, a measurement report associated with the downlink signal. The apparatus may include means for updating the transmissive surface information in accordance with the measurement report, where the transmissive surface information includes one or more of: a transmissive surface location, attribute information associated with the transmissive surface, one or more SSB parameters, or SSB beam information.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example associated with transmissive surface identification, in accordance with the present disclosure.

FIG. 4 is a diagram illustrating an example associated with a data marker associated with a transmissive surface, in accordance with the present disclosure.

FIG. 5 is a diagram illustrating an example associated with accessing a database storing transmissive surface information, in accordance with the present disclosure.

FIG. 6 is a diagram illustrating an example associated with a trajectory monitoring system, in accordance with the present disclosure.

FIG. 7 is a diagram illustrating an example associated with transmissive surface identification, in accordance with the present disclosure.

FIG. 8 is a diagram illustrating an example process performed, for example, at a user equipment (UE) or an apparatus of a UE, in accordance with the present disclosure.

FIG. 9 is a diagram illustrating an example process performed, for example, at a network node or an apparatus of a network node, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A synchronization signal block (SSB) is a transmission that enables a user equipment (UE) to synchronize with a network node. The SSB may include one or more synchronization signals, such as a primary synchronization signal (PSS) and a secondary synchronization signal (SSS). The SSB may further include a broadcast channel that may carry system information. The SSB may be transmitted within a specified time and frequency resource of a physical channel. The SSB may facilitate operations such as cell search, synchronization, and the acquisition of system information by the UE. The SSB may be periodically transmitted by the network node, and the synchronization signals within the SSB may allow the UE to determine at least one of timing, frequency, and cell identity of the network node. The SSB may be transmitted using a particular beam pattern, and the transmission of the SSB may be configured to support beam sweeping, where the SSB may be transmitted in different directions over multiple time intervals to provide coverage within a particular area.

Penetration loss, which is a reduction in signal strength, may occur when a wireless signal passes through a physical barrier. In the context of a building, such as a home or workplace, penetration loss may be caused by building materials such as walls, windows, or doors. Penetration loss may also occur in passenger vehicles, trains, and busses, among other examples. Some materials may cause more penetration loss than other materials. For example, low-emissivity (low-E) glass is treated with a thin metallic coating to reduce heat transfer. The metallic coating, however, contributes to penetration loss by increasing attenuation of radio frequency signals. The attenuation caused by low-E glass is not always consistent. For example, the attenuation of the radio frequency signals by low-E glass may depend on factors such as a frequency of the wireless signal, a thickness of the low-E glass, and one or more properties of the metallic coating applied to the glass. The reduced signal strength caused by penetration loss can result in reduced wireless coverage and higher latency, among other examples.

One way to combat penetration loss is with a transmissive surface that permits the passage of a wireless signal from one side of the surface to another with less attenuation than, for example, low-E glass or other materials. The transmissive surface may have properties that allow partial or complete transmission of radio frequency signals. For example, the transmissive surface may be formed from glass, plastic, a composite material, by removing, etching or shaping the metallic coating associated with the low-E glass, and/or a combination thereof, among other examples. The transmissive surface may have properties that reduce the propagation loss of the wireless signal. For example, the transmissive surface may have a thickness, material composition, and/or surface treatment that reduces attenuation relative to the attenuation caused by low-E glass.

While transmissive surfaces can improve network performance, using too many transmissive surfaces, or using transmissive surfaces that are too large, can create other issues. For example, although transmissive surfaces cause less radio frequency signal attenuation than low-E glass, transmissive surfaces may not prevent heat transfer as well as the low-E glass. Accordingly, transmissive surfaces may be smaller and placed strategically throughout a building so that the radio frequency signal attenuation can be reduced without significantly increasing heat transfer. A smaller transmissive surface may require a network node and a UE to communicate on more precise beams that take advantage of the transmissive surface.

Additionally, for aesthetic reasons, transmissive surfaces may be incorporated into, and may be designed to blend together with, other surfaces. For example, a section of a glass window may not be a coated with the thin metallic coating to allow the uncoated section of the window to operate as a transmissive surface. When blended together well enough, the transmissive surface may be camouflaged by the non-transmissive surface, which makes the transmissive surface difficult for a user to find.

One way to make transmissive surfaces more noticeable to users is with a data marker. The data marker may be a physical indicator that may be used to identify the location or presence of a transmissive surface. For example, the data marker may include at least one visual element that may be discernible by a user or a UE (e.g., via a camera or sensor). The visual element may be a pattern, a color, or a code. The data marker may also include passive or active signaling elements, such as a quick response (QR) code, a radio frequency identification (RFID) tag, or any other identifier that may be detected by a reader or sensing device. The data marker may store or otherwise include information associated with the transmissive surface. For example, the data marker may have a database or a link to a database that provides information such as dimensions, an orientation, a location, and/or a combination thereof, among other examples, of the transmissive surface. With the information stored on or accessed via the data marker the UE and/or network node can direct communications through the transmissive surface.

Various aspects relate generally to communicating using transmissive surfaces. Some aspects more specifically relate to using a data marker to identify a transmissive surface. In some aspects, the data marker provides information about the transmissive surface to a UE. In some aspects, the UE provides information, about communications via the transmissive surface, to a network entity. In some aspects, the UE receives transmissive surface information via a data marker. The UE may receive a downlink signal via the transmissive surface associated with the transmissive surface information. The UE may transmit a measurement report associated with the downlink signal received via the transmissive surface. In some aspects, the transmissive surface information includes a transmissive surface location, attribute information associated with the transmissive surface, one or more SSB parameters, and/or SSB beam information. In some aspects, the data marker may be used to determine an antenna panel orientation of the UE relative to the transmissive surface. In some aspects, the UE may receive the transmissive surface information via the data marker by accessing, via a uniform resource located (URL) embedded in the data marker, a database that includes the transmissive surface information.

Particular aspects of the subject matter described in this disclosure can be implemented to realize one or more of the following potential advantages. In some examples, the described techniques can be used to improve beamforming so that, for example, communications between a network node and a UE pass through a transmissive surface. In some aspects, by using the data marker to determine the orientation of the antenna panel of the UE relative to the antenna surface, the network node may perform a more precise beamforming operation that can result in improved network performance. In some aspects, by embedding a database in the data marker, the UE and the network node can access and/or update information associated with the transmissive surface in real time.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

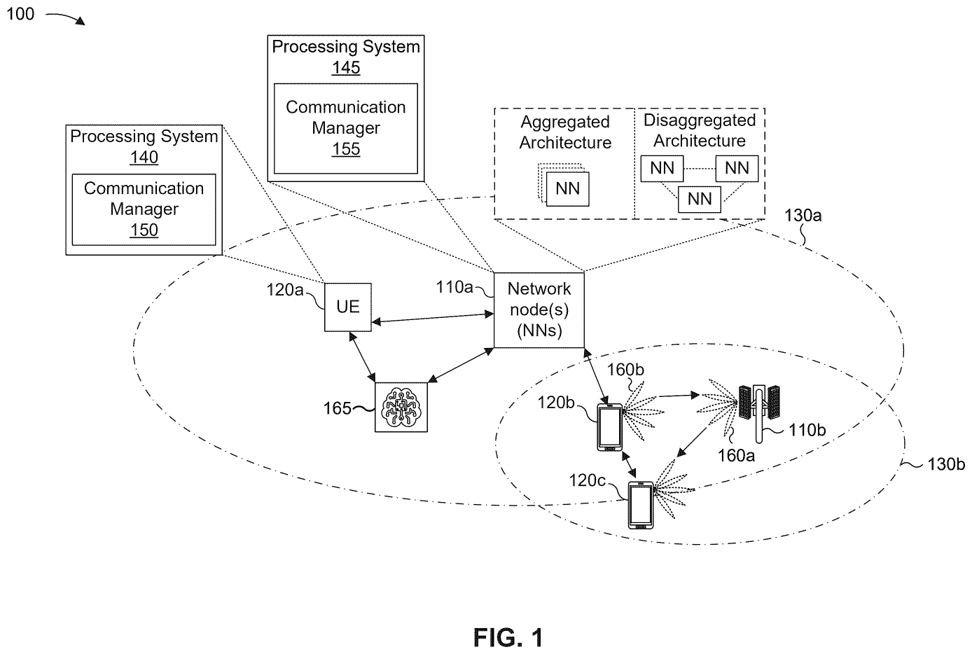

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

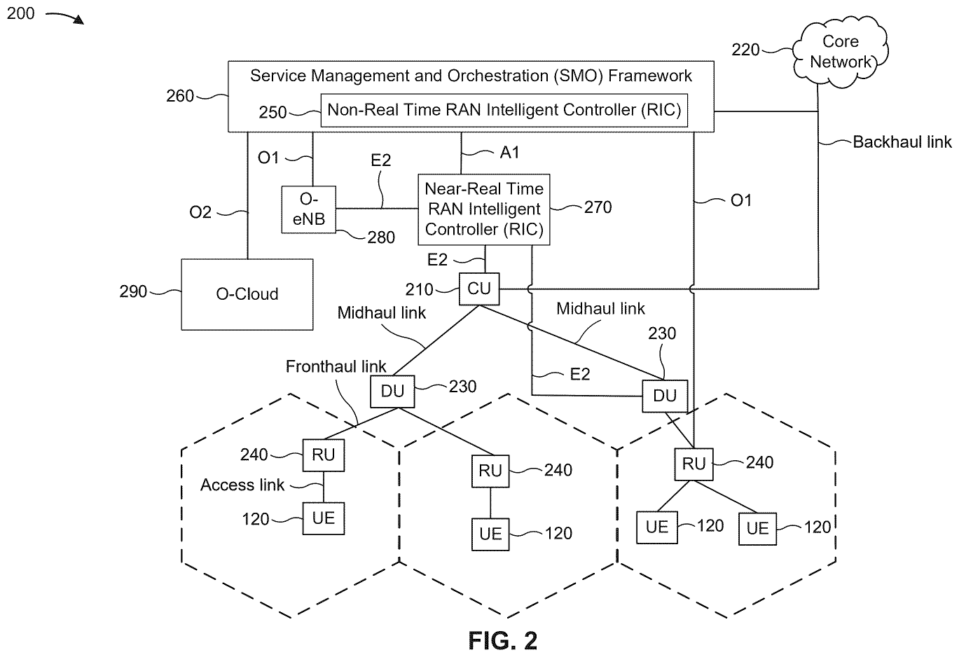

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, smart jewelry, a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a PSS, an SSS, an SSB (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)—reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Further efficiencies in throughput, signal strength, and/or other signal properties may be achieved through beam refinement. For example, the network node 110 may be capable of communicating with the UE 120 using beams (for example, beam(s) 160a) of different beam widths. In some examples, the network node 110 may be configured to utilize a wider beam to communicate with the UE 120 when the UE 120 is in motion or for initial beam acquisition because wider coverage may increase the likelihood that the mobile UE 120 remains in coverage of the network node 110 while communicating using the wider beam. Conversely, the network node 110 may use a narrower beam to communicate with the UE 120 when the UE 120 is stationary because the network node 110 can reliably focus coverage on the UE 120 with low or minimal likelihood of the UE 120 moving out of the coverage area of the narrower beam. In some examples, to select a particular beam (for example, from the beam(s) 160a) for communication with a UE 120, the network node 110 may transmit a reference signal, such as an SSB or a CSI-RS, on each of a plurality of beams in a beam-sweeping manner. In some examples, SSBs may be transmitted on wider beams, whereas CSI-RSs may be transmitted on narrower beams. The UE 120 may measure the RSRP or the signal-to-interference-plus-noise ratio (SINR) on each of the beams and transmit a beam measurement report (for example, a Layer 1 (L1) measurement report) to the network node 110 indicating the RSRP or SINR associated with each of one or more of the measured beams. The network node 110 may then select the particular beam for communication with the UE 120 based on the L1 measurement report. In some other examples, when there is channel reciprocity between the uplink and the downlink, the network node 110 may derive the particular beam to communicate with the UE 120 (for example, on both the uplink and downlink) based on uplink measurements of one or more uplink reference signals, such as an SRS, transmitted by the UE 120.

In some aspects, the UE 120 may include a communication manager 150. As described in more detail elsewhere herein, the communication manager 150 may receive transmissive surface information via a data marker; receive a downlink signal via a transmissive surface associated with the transmissive surface information; and transmit a measurement report associated with the downlink signal received via the transmissive surface, wherein the transmissive surface information includes one or more of: a transmissive surface location, attribute information associated with the transmissive surface, one or more SSB parameters, or SSB beam information. Additionally, or alternatively, the communication manager 150 may perform one or more other operations described herein.

In some aspects, the network node 110 may include a communication manager 155. As described in more detail elsewhere herein, the communication manager 155 may output, for a UE 120, a downlink signal via a transmissive surface associated with transmissive surface information available via a data marker; receive, from the UE 120, a measurement report associated with the downlink signal; and update the transmissive surface information in accordance with the measurement report, wherein the transmissive surface information includes one or more of: a transmissive surface location, attribute information associated with the transmissive surface, one or more SSB parameters, or SSB beam information. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

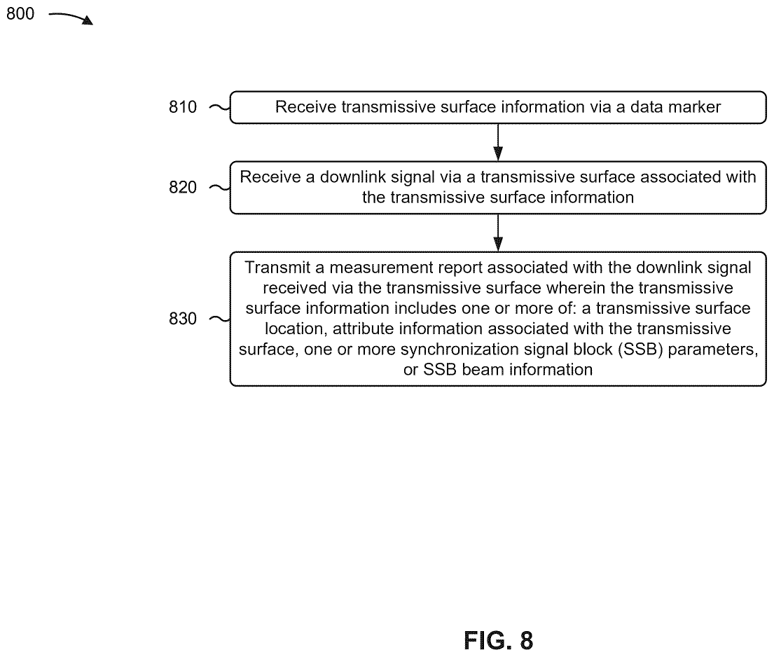

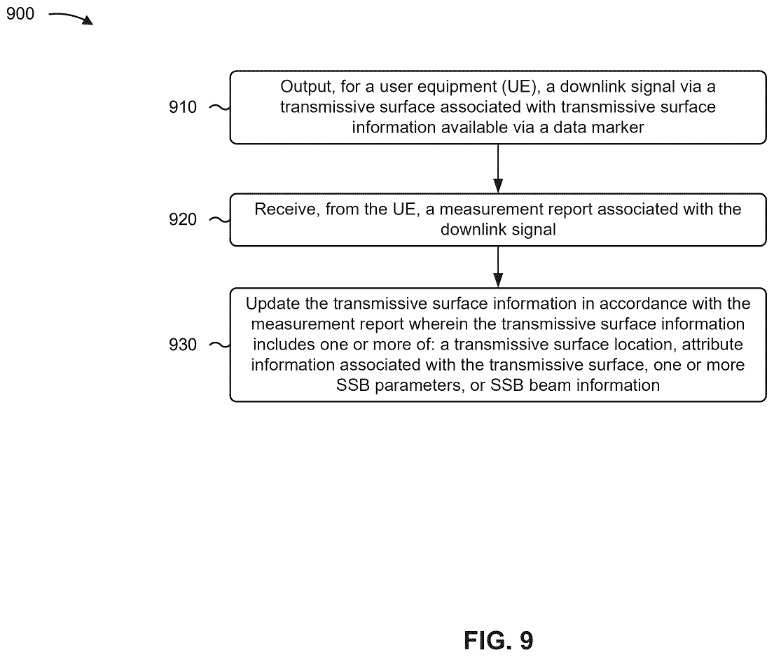

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with transmissive surface identification, as described in more detail elsewhere herein. For example, the processing system 145 of the network node 110, the processing system 140 of the UE 120, the CU 210, the DU 230, or the RU 240 may perform or direct operations of, for example, process 800 of FIG. 8, process 900 of FIG. 9, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 800 of FIG. 8, process 900 of FIG. 9, or other processes as described herein. In some examples, executing instructions may include running the instructions, converting the instructions, compiling the instructions, and/or interpreting the instructions, among other examples.

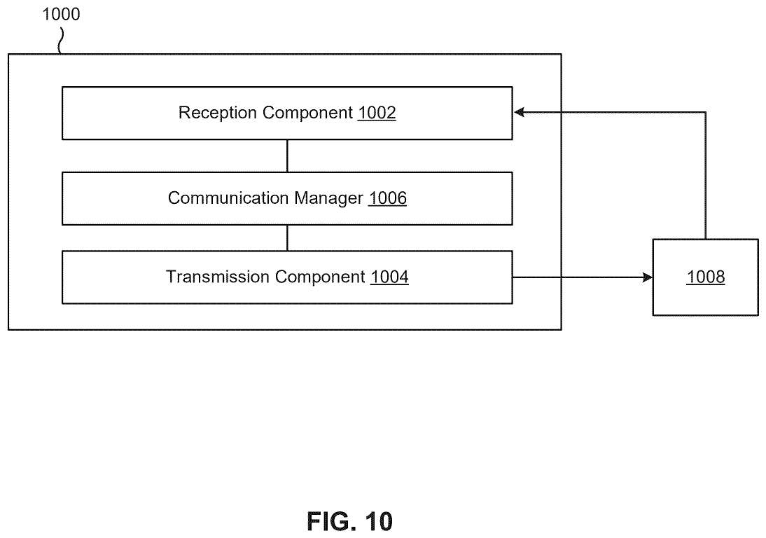

In some aspects, the UE 120 includes means for receiving transmissive surface information via a data marker; means for receiving a downlink signal via a transmissive surface associated with the transmissive surface information; and/or means for transmitting a measurement report associated with the downlink signal received via the transmissive surface, wherein the transmissive surface information includes one or more of: a transmissive surface location, attribute information associated with the transmissive surface, one or more SSB parameters, or SSB beam information. The means for the UE 120 to perform operations described herein may include, for example, one or more of communication manager 150, processing system 140, a radio, one or more RF chains, one or more transceivers, one or more antennas, one or more modems, a reception component (for example, reception component 1002 depicted and described in connection with FIG. 10), and/or a transmission component (for example, transmission component 1004 depicted and described in connection with FIG. 10), among other examples.

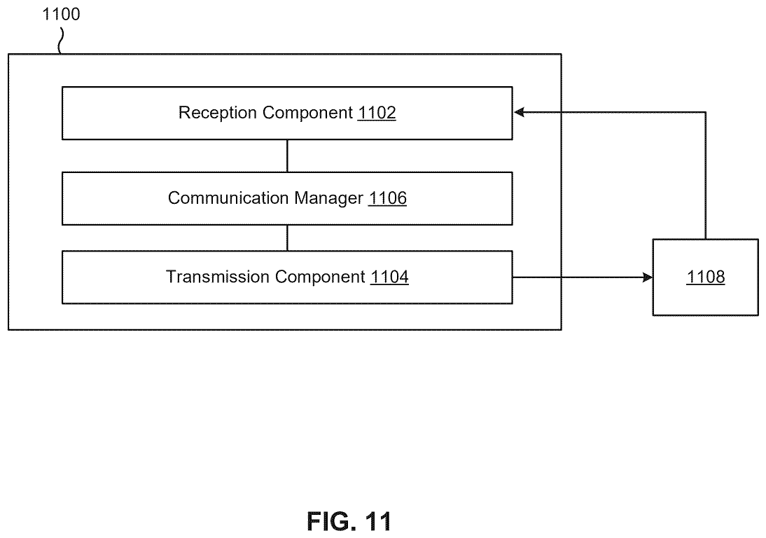

In some aspects, the network node 110 includes means for outputting, for a UE 120, a downlink signal via a transmissive surface associated with transmissive surface information available via a data marker; means for receiving, from the UE 120, a measurement report associated with the downlink signal; and/or means for updating the transmissive surface information in accordance with the measurement report, wherein the transmissive surface information includes one or more of: a transmissive surface location, attribute information associated with the transmissive surface, one or more SSB parameters, or SSB beam information. The means for the network node to perform operations described herein may include, for example, one or more of communication manager 155, processing system 145, a radio, one or more RF chains, one or more transceivers, one or more antennas, one or more modems, a reception component (for example, reception component 1102 depicted and described in connection with FIG. 11), and/or a transmission component (for example, transmission component 1104 depicted and described in connection with FIG. 11), among other examples.

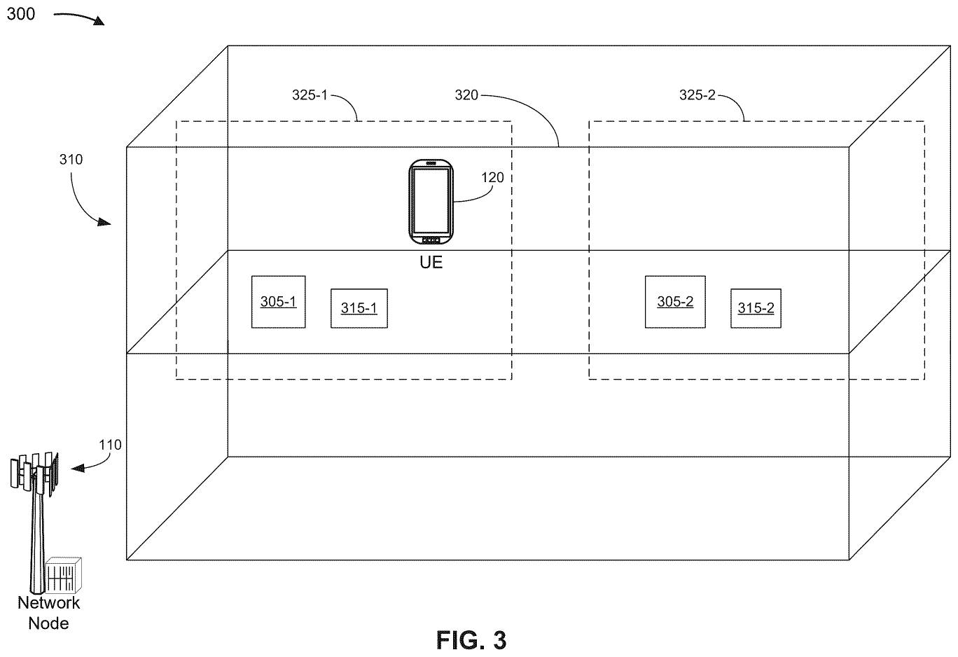

FIG. 3 is a diagram illustrating an example 300 associated with transmissive surface identification, in accordance with the present disclosure. As shown in FIG. 3, example 300 includes communication between a network node 110 and a UE 120. In some aspects, the network node 110 and the 120 may be included in a wireless network, such as wireless network 100. The network node 110 and the 120 may communicate via a wireless access link, which may include an uplink and a downlink. Communications between the network node 110 and the UE 120 may occur via transmissive surfaces 305 located on walls, windows, or other objects of a facility 310. The facility 310 may be a commercial building, an industrial building, or a residential building, among other examples. The walls may be formed from materials such as brick, wood, drywall, concrete, and/or a combination thereof, among other examples. The windows may be formed from objects including glass. One or more of the transmissive surfaces 305 may be associated with a data marker 315.

In some aspects, the transmissive surfaces 305 are located on a glass façade 320. In some aspects, the glass façade 320 may be a window, such as a low-E window. The transmissive surface 305 may be a section of the glass façade 320 that does not exhibit low-E properties. For example, the transmissive surface 305 may be a section of the glass façade 320 that does not have a metallic low-E coating or that has metallic low-E coating that has been shaped and reduced. By omitting the metallic low-E coating, or by shaping and reducing the metallic low-E coating, the transmissive surface 305 may cause less attenuation of radio frequency signals, including mmWave signals, than the low-E glass portions of the glass façade 320. Accordingly, the transmissive surfaces 305 may exhibit lower penetration loss and additionally, in some aspects, may pass through and direct an incident signal with a broader footprint along a certain direction, than the low-E glass portions of the glass façade 320. Communicating via the transmissive surfaces 305, therefore, may improve network performance by, for example, decreasing latency, increasing signal strength, increasing coverage area, and/or a combination thereof, among other examples.

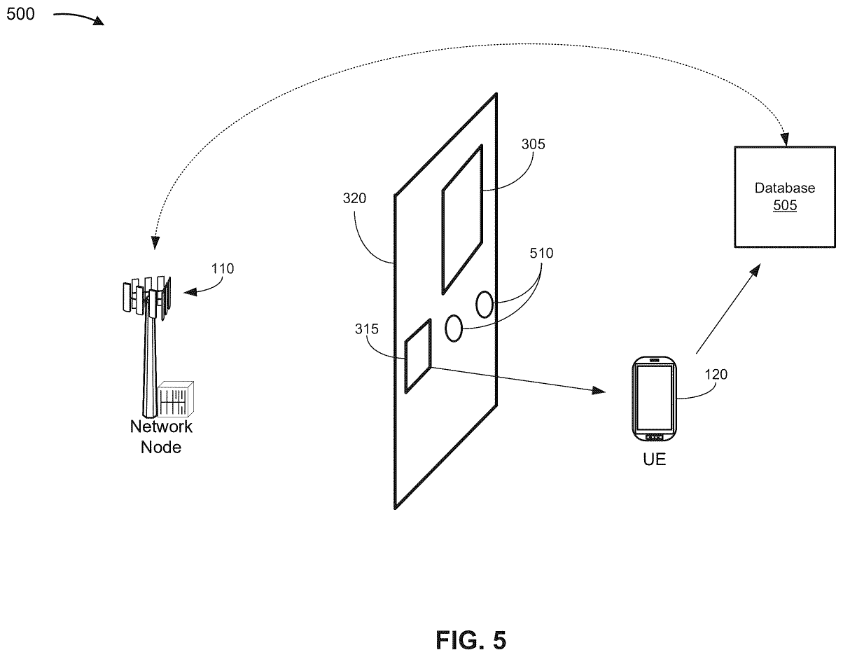

Each data marker 315 may be located on or embedded within one (or within a vicinity) of the transmissive surfaces 305 in a facility 310 to facilitate communication between the UE 120 as a remote database (see FIG. 5). In some aspects, the data marker 315 is or includes a QR code or radio frequency identifier (RFID) tag that may allow the UE 120 to access transmissive surface information stored in a database.

In some aspects, the UE 120 may communicate with the network node 110 (e.g., a gNB or a transmission and reception point (TRP)) through different transmissive surfaces 305 as the UE 120 moves or is moved throughout the facility 310. For example, when the UE 120 is located in a first area 325-1 of the facility 310, the UE 120 may communicate with the network node 110 via a first transmissive surface 305-1. When the UE 120 is located in a second area 325-2 of the facility 310, the UE 120 may communicate with the network node 110 via a second transmissive surface 305-2. In some aspects, the UE 120 may communicate with the network node 110 in accordance with the transmissive surface information stored in or accessed via the data marker 315 associated with each transmissive surface 305. For example, to communicate with the network node 110 via the first transmissive surface 305-1, the UE 120 may access information about the first transmissive surface 305-1 via a first data marker 315-1. To communicate with the network node 110 via the second transmissive surface 305-2, the UE 120 may access information about the second transmissive surface 305-2 via a second data marker 315-2. In other aspects, any one of or both the first and second data markers 315-1, 315-2 may provide information (or access to a database containing information) about both transmissive surfaces 305-1 and 305-2.

In some aspects, the network node 110 may use information collected by the data marker 315 to track the UE 120 in the facility 310. For example, each data marker 315 may record when the UE 120 has accessed the data marker 315. After the UE 120 accesses a data marker 315, the network node 110 may be notified that the UE 120 accessed a data marker 315 and given a location of the data marker 315 accessed by the UE 120. For example, as a result of the UE 120 accessing the first data marker 315-1, the network node 110 may be notified, by the data marker 315 or by an update to the database accessed via the data marker 315, among other examples, that the UE 120 accessed the first data marker 315-1. If the first data marker 315-1 is fixed in a location in the first area 325-1 of the facility 310, the network node 110 may determine that the UE 120 is also located in the first area 325-1 of the facility 310. With the location of the UE 120, the network node 110 may perform a beamforming operation to direct communications with the UE 120 toward the first transmissive surface 305-1.

In some aspects, the data marker 315 may include one or more alignment markers that help orient the UE 120 relative to the data marker 315, one or more position markers that help the UE 120 determine a location within the facility 310, and/or a combination thereof, among other examples. In some aspects, properties of the data marker 315 may be varied to facilitate different detection ranges and robustness. Examples of properties of the data marker 315 may include color contrast, prominent position indicators, redundancy of embedded data, and/or a combination thereof, among other examples.

In some aspects, the data marker 315 may facilitate side information communication between the network node 110 and the UE 120. For example, the network node 110 may provide the UE 120 with side information that includes details about one or more properties of the data marker 315, a geometric shape of the transmissive surface 305, and/or a combination thereof, among other examples, to help the UE 120 scan the data marker 315 and orient one or more beams to improve communication with the network node 110 via the transmissive surface 305.

As indicated above, FIG. 3 is provided as an example. Other examples may differ from what is described with respect to FIG. 3.

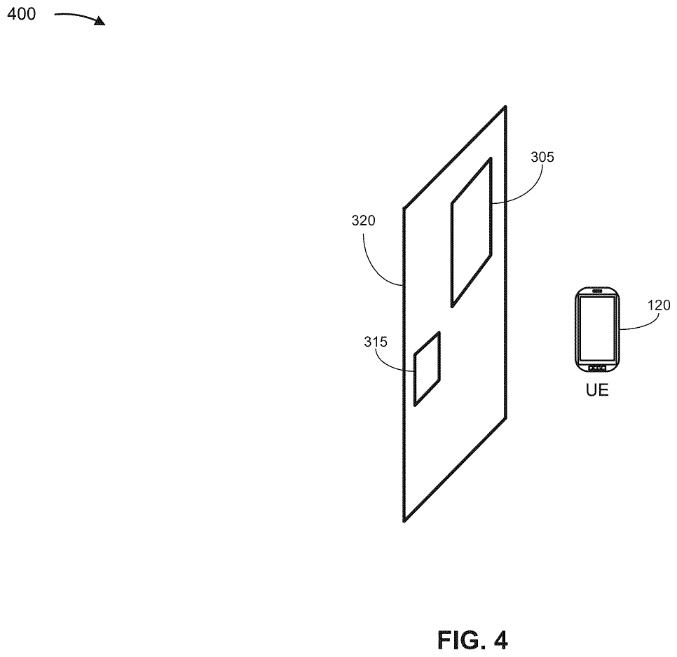

FIG. 4 is a diagram illustrating an example 400 associated with a data marker 315 associated with a transmissive surface 305, in accordance with the present disclosure. As shown in FIG. 4, a transmissive surface 305 may be located embedded in a glass façade 320. A data marker 315 may be located on the glass façade 320. In some aspects, the data marker 315 may be located on or near the transmissive surface 305. In some aspects, the data marker 315 may include an encoded or embedded URL that allows the UE 120 to access a database (see FIG. 5, below), which may maintain information regarding the transmissive surface 305 and beams that may be used for communication between a network node (e.g., network node 110) and a UE (e.g., UE 120). The placement of the data marker 315 may be on a conformal surface, which may allow the UE 120 to scan the data marker 315.

In some aspects, the data marker 315 may be a QR code. In some aspects, the data marker 315 may be an RFID tag. In some aspects, the UE 120 may scan, read, or otherwise communicate with the data marker 315 and access the database via a wireless communication system such as a WiFi communication system or a cellular communication system. In some aspects, the data marker 315 may authenticate the UE 120 before allowing the UE 120 to access the database. In some aspects, the data marker 315 may include encryption, which may allow only authorized users, such as subscribers of a specific operator, to access the database via the encoded URL. In some aspects, the data marker 315 may grant access to the UE 120 in accordance with a temporary pass or as a result of a purchase.

As indicated above, FIG. 4 is provided as an example. Other examples may differ from what is described with respect to FIG. 4.

FIG. 5 is a diagram illustrating an example 500 associated with accessing a database storing transmissive surface information, in accordance with the present disclosure. As shown in FIG. 5, example 500 includes communication between a network node 110 and a UE 120. In some aspects, the network node 110 and the UE 120 communicate via a transmissive surface 305. In some aspects, the UE 120 may access a database 505 via a data marker 315. For example, in some aspects, the UE 120 may access the database 505 via an encoded URL of the data marker 315.

Upon scanning the data marker 315, the UE 120 may inform the network node 110 of access to the database 505 or the presence of a transmissive surface 305 within the facility. Alternatively, the network node 110 may configure the UE 120 to proactively scan for one or more data markers 315, such as QR codes or other RFID tags. In some aspects, the network node 110 may configure the UE 120 to scan for one or more data markers 315 in accordance with prior knowledge from operations and management (OAM) or using information obtained from UEs that previously scanned the data marker 315.

In some aspects, the database 505 may contain one or more attributes related to the transmissive surface 305. In some aspects, the attributes may include one or more of coordinates of the data marker 315 with respect to a global coordinate system associated with a facility (e.g., the facility 310 of FIG. 3), a location of a reference point on the transmissive surface 305, and dimensions or a span of the transmissive surface 305 relative to the data marker 315. The transmissive surface 305 attributes may further include a transmissive field-of-view, which may be defined with respect to the reference point and a threshold value. In some aspects, the database 505 may include a look-up table (LUT) that includes one or more values associated with an effective gain or an attenuation-versus-distance parameter. In some aspects, by accessing the database 505, the UE 120 may interpret signal characteristics at varying distances from the transmissive surface 305.

In some aspects, the database 505 may also include one or more SSB beam attributes associated with the transmissive surface 305. In some aspects, the SSB beam attributes may include one or more of a beam-pointing angle, a beam width, a beam tilt, a repetition factor, and/or a combination thereof, among other examples. In some aspects, the UE 120 may use the SSB beam attributes to facilitate communication with the network node 110 through the transmissive surface 305 more efficiently than through other surfaces of the facility, such as through low-E glass.

In some aspects, the database 505 may be maintained or updated periodically. In some aspects, the database 505 may be updated in accordance with one or more activities associated with the UE 120. For example, in some aspects, the database 505 may be updated as a result of tracking, by the data marker 315, by the network node 110, by the UE 120, and/or a combination thereof, among other examples, which data markers 315 are accessed most frequently. In some aspects, usage of the data markers 315 may reveal traffic patterns associated with one or more UEs within the facility. In some aspects, the UE 120 may be configured to report sensor data upon scanning the data marker 315, which may facilitate real-time monitoring of one or more conditions of the facility related to network connectivity. In some aspects, the network node 110 may update one or more transmission parameters in accordance with one or more reports output by the UE 120. For example, the network node 110 may update one or more transmission parameters as a result of one or more SSB measurement reports transmitted by the UE 120.

In some aspects, one or more feature points 510 may be located on the glass façade 320, near the transmissive surface 305, near the data marker 315, and/or a combination thereof, among other examples. In some aspects, the feature points 510 may include one or more geometric shapes, colors, or other indications associated with one or more transmissive surfaces 305. In some aspects, the feature points 510 may provide an image that the UE 120 can process to facilitate stereo-correspondence, which may allow the UE 120 to measure a depth (e.g., a UE-to-transmissive surface 305 distance) and/or to estimate an inter-transmissive surface 305 separation.

As indicated above, FIG. 5 is provided as an example. Other examples may differ from what is described with respect to FIG. 5.

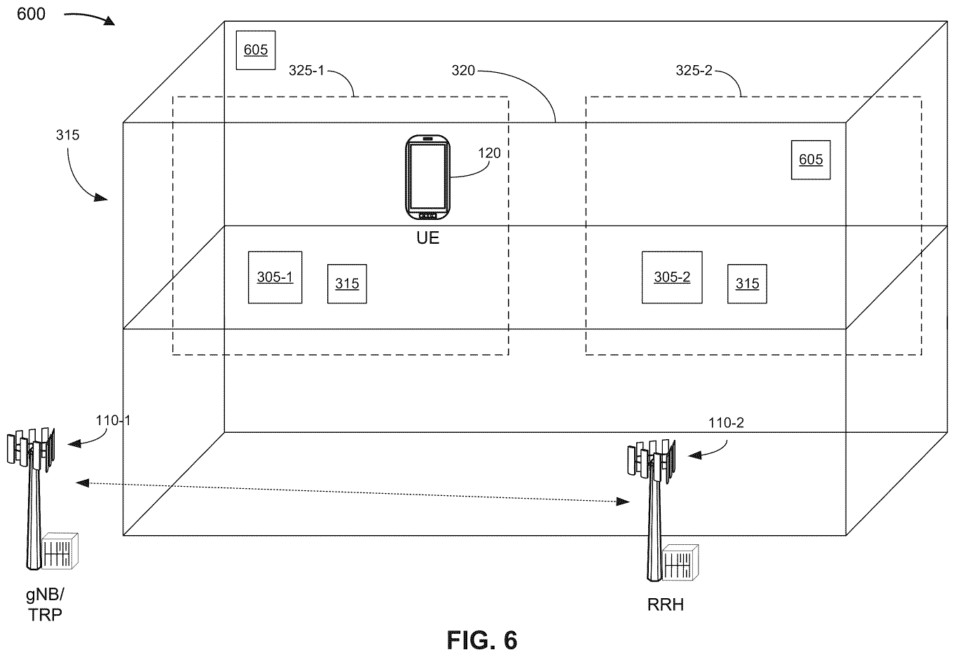

FIG. 6 is a diagram illustrating an example 600 associated with a trajectory monitoring system, in accordance with the present disclosure. As shown in FIG. 6, example 600 includes communication between a first network node 110-1, a second network node 110-1, and a UE 120 via one or more transmissive surfaces 305, including a first transmissive surface 305-1 and a second transmissive surface 305-2.

In some aspects, the trajectory monitoring system shown in the example 600 of FIG. 6 may allow a network to manage communications with a UE 120 in accordance with positioning of the UE 120 within a facility that includes the one or more transmissive surfaces 305.

In some aspects, the UE 120 may communicate with the first network node 110 (e.g., a TRP or gNB) via signals that pass through the first transmissive surface 305-1. In some aspects, the UE 120 may acquire orientation data relative to the first transmissive surface 305-1 by obtaining information from a first data marker 315-1 associated with the first transmissive surface 305-1. In some aspects, the UE 120 may access transmissive surface information, stored in the database, that may relate to an orientation and/or attributes of the first transmissive surface 305-1. The transmissive surface information accessed via the database and first data marker 315-1 may allow the UE 120 to calculate orientation angles and antenna panel positions relative to the first transmissive surface 305-1.

In some aspects, the trajectory monitoring system may include one or more motion sensors 605 for tracking a motion direction of the UE 120. Based on an output of the motion sensors 605, the UE 120 and/or the first network node 110-1 may identify additional transmissive surfaces 305 (e.g., the second transmissive surface 305-2) that may serve as candidates for future communications. In some aspects, the trajectory monitoring system may allow the first network node 110-1 to predict a future path of the UE 120 within the facility. By predicting the future path, the first network node 110-1 may identify which transmissive surfaces 305 may be used for subsequent communications with the UE 120.

In some aspects, the first network node 110-1 may coordinate with the UE 120 and/or the second network node 110-2 to facilitate antenna panel switching and TRP or remote radio head (RRH) switching. In some aspects, the first network node 110-1 may provision time gaps, reference symbol resources, and additional side information for scanning activities conducted by the UE 120. In some aspects, the first network node 110-1 may use the information available from the database and the trajectory information to proactively determine an antenna panel and TRP or RRH for subsequent communication sessions with the UE 120 via the first network node 110-1 and/or the second network node 110-2.

In some aspects, the UE 120 may determine one or more antenna panel orientations and transmissive surface 305 positions. In some aspects, the UE 120 may determine the one or more antenna panel orientations and transmissive surface 305 positions by analyzing sensor data, information from one or more data markers 315, and data from the database. In some aspects, the UE 120 may use received or accessed information to determine an appropriate beam management strategy. In some aspects, the UE 120 may switch between antenna panels to align with a predicted future position relative to the transmissive surface 305, in accordance with the information obtained from the network node 110, the database, and one or more motion sensors 605.

In some aspects, the trajectory monitoring system may operate within an environment that may include multiple transmissive surfaces 305 and different types of materials such as concrete barriers, sidewalls, and glass façades. In some aspects, the UE 120 may track its position relative to one or more of the structures in the facility using one or more data markers 315, an output of one or more motion sensors 605, information received from the network node 110, and/or a combination thereof, among other examples. In some aspects, as discussed above, the network node 110 may continuously monitor the trajectory of the UE 120 and make dynamic adjustments to the beamforming strategy to improve alignment between the UE 120 and the transmissive surfaces 305.

In some aspects, the UE 120 may transmit one or more reports to the network node 110. In some aspects, the UE 120 may transmit the one or more reports in accordance with information received or accessed as a result of scanning one or more of the data markers 315 or communicating with one or more of the motion sensors 605. In some aspects, the first network node 110-1 and/or the second network node 110-2 may use the reports output by the UE 120 to make real-time updates to the database and adjust transmission characteristics, such as beam orientation or a panel switching strategy, to align with the predicted trajectory of the UE 120.

As indicated above, FIG. 6 is provided as an example. Other examples may differ from what is described with respect to FIG. 6.

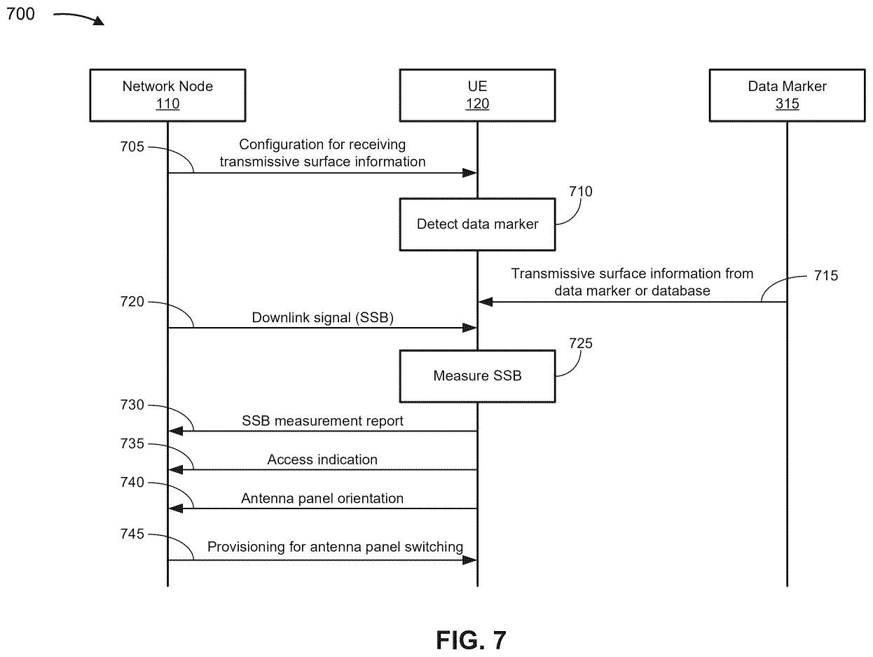

FIG. 7 is a diagram illustrating an example 700 associated with transmissive surface identification, in accordance with the present disclosure. As shown in FIG. 7, a network node 110 and a UE 120 may communicate with one another.

As shown by reference number 705, the UE 120 may receive, and the network node 110 may transmit, a configuration for receiving a transmissive surface information. In some aspects, the configuration for receiving the transmissive surface information may configure the UE 120 to scan for or otherwise communicate with one or more data markers 315 at a facility. In some aspects, the data markers 315 may be associated with one or more transmissive surfaces, and the UE 120 may be configured to access a database storing the transmissive surface information via the data markers 315.

As shown by reference number 710, the UE 120 may detect one or more data markers 315. In some aspects, the UE 120 may detect the one or more data markers 315 at a facility in accordance with the configuration for receiving the transmissive surface information. In some aspects, detecting the one or more data markers 315 may include detecting one or more of a location or an orientation of the UE 120 relative to at least one of the one or more data markers 315.

As shown by reference number 715, the UE 120 may receive transmissive surface information. In some aspects, the UE 120 may receive the transmissive surface information by accessing a database. In some aspects, the UE 120 may receive the transmissive surface information from a data marker 315. In some aspects, the data marker 315 is a passive tag (e.g., a QR code) or an active tag (e.g., an RFID tag). In some aspects, the UE 120 may receive the transmissive surface information by scanning the passive tag, accessing a database storing the transmissive surface information, and querying the database for the transmissive surface information stored in the database. In some aspects, the UE 120 may access the data base via a URL embedded in the data marker 315. In some aspects, the URL embedded in the data marker 315 may be encrypted. In some aspects, the UE 120 may optically scan the data marker 315 to access the transmissive surface information. In some aspects, the UE 120 may receive the transmissive surface information transmitted by the data marker 315. For example, in some aspects, the UE 120 may receive a wireless signal output by the data marker 315. In some aspects, the transmissive surface information may include one or more of a transmissive surface location, attribute information associated with the transmissive surface, one or more SSB parameters, or SSB beam information. In some aspects, the attribute information associated with the transmissive surface may include one or more of a dimension span, a curvature, a field of view, a reference point location, a data marker 315 location, an effective gain parameter, an attenuation parameter, a geometric shape, or a color. In some aspects, the one or more SSB parameters may be associated with a network node 110 or a TRP associated with the transmissive surface. In some aspects, the one or more SSB parameters may include one or more of an SSB index, an SSB periodicity, or an SSB repetition factor. In some aspects, the SSB beam information may include one or more of a pointing angle of an SSB beam, a field of view of the SSB beam, a coverage footprint of the SSB beam, a width of the SSB beam, or a tilt of the SSB beam. In some aspects, the transmissive surface information may include an RSRP offset associated with one or more network nodes 110 or TRPs. In some aspects, the transmissive surface information may include one or more cell identifiers.

As shown by reference number 720, the UE 120 may receive, and the network node 110 may transmit, a downlink signal. In some aspects, the UE 120 may receive the downlink signal via the transmissive surface associated with the transmissive surface information obtained by the UE 120. In some aspects, the UE 120 may receive the downlink signal on a downlink channel or a broadcast channel. In some aspects, the downlink signal may be an SSB.

As shown by reference number 725, the UE 120 may measure the SSB transmitted by the network node 110. In some aspects, the SSB may contain one or more synchronization signals and a PBCH. In some aspects, the UE 120 may be configured to detect and synchronize with the network node 110 in accordance with the SSB.

As shown by reference number 730, the UE 120 may transmit, and the network node 110 may receive, a measurement report associated with the downlink signal received via the transmissive surface. In some aspects, the measurement report may include information about the downlink signal including an RSRP, RSSI, and/or RSRQ associated with the downlink signal. For example, the UE 120 may determine the RSRP, RSSI, and/or RSRQ in accordance with a measurement of the SSB.

As shown by reference number 735, the UE 120 may transmit, and the network node 110 may receive, an access indication. In some aspects, the access indication may indicate, to the network node 110, that the UE 120 communicated with the data marker 315, accessed the database via the data marker 315, received the transmissive surface information, and/or a combination thereof, among other examples.

As shown by reference number 740, the UE 120 may transmit, and the network node 110 may receive, an antenna panel orientation. In some aspects, the antenna panel orientation may be an orientation of an antenna panel of the UE 120 relative to the transmissive surface. With the antenna panel orientation, the network node 110 and UE 120 may perform one or more beamforming operations to improve communications between the UE 120 and network node 110 via the transmissive surface.

As shown by reference number 745, the UE 120 may receive, and the network node 110 may transmit, provisioning for antenna panel switching. In some aspects, the provisioning for antenna panel switching may be associated with one or more of a serving TRP or a serving RRH. In some aspects, the provisioning for antenna panel switching associated with the one or more of the serving TRP or the serving RRH may include provisioning for at least one of one or more reference symbol resources or a time gap. In some aspects, the network node 110 may proactively provision the reference symbol resources and/or the time gap in accordance with information captured by one or more motion sensors located at a facility. Accordingly, the network node 110 may proactively apply beam management in accordance with movement of the UE 120 throughout the facility.

As indicated above, FIG. 7 is provided as an example. Other examples may differ from what is described with respect to FIG. 7.

FIG. 8 is a diagram illustrating an example process 800 performed, for example, at a UE or an apparatus of a UE, in accordance with the present disclosure. Example process 800 is an example where the apparatus or the UE (e.g., UE 120) performs operations associated with transmissive surface identification.

As shown in FIG. 8, in some aspects, process 800 may include receiving transmissive surface information via a data marker (block 810). For example, the UE (e.g., using reception component 1002 and/or communication manager 1006, depicted in FIG. 10) may receive transmissive surface information via a data marker, as described above.

As further shown in FIG. 8, in some aspects, process 800 may include receiving a downlink signal via a transmissive surface associated with the transmissive surface information (block 820). For example, the UE (e.g., using reception component 1002 and/or communication manager 1006, depicted in FIG. 10) may receive a downlink signal via a transmissive surface associated with the transmissive surface information, as described above.

As further shown in FIG. 8, in some aspects, process 800 may include transmitting a measurement report associated with the downlink signal received via the transmissive surface, wherein the transmissive surface information includes one or more of: a transmissive surface location, attribute information associated with the transmissive surface, one or more SSB parameters, or SSB beam information (block 830). For example, the UE (e.g., using transmission component 1004 and/or communication manager 1006, depicted in FIG. 10) may transmit a measurement report associated with the downlink signal received via the transmissive surface, wherein the transmissive surface information includes one or more of: a transmissive surface location, attribute information associated with the transmissive surface, one or more SSB parameters, or SSB beam information, as described above.

Process 800 may include additional aspects, such as any single aspect or any combination of aspects described below and/or in connection with one or more other processes described elsewhere herein.

In a first aspect, the attribute information associated with the transmissive surface includes one or more of a dimension span, a curvature, a field of view, a reference point location, a data marker location, an effective gain parameter, an attenuation parameter, a geometric shape, or a color.

In a second aspect, alone or in combination with the first aspect, process 800 includes transmitting an antenna panel orientation relative to the transmissive surface.

In a third aspect, alone or in combination with one or more of the first and second aspects, process 800 includes receiving provisioning for antenna panel switching associated with one or more of a serving TRP or a serving RRH.

In a fourth aspect, alone or in combination with one or more of the first through third aspects, the provisioning for antenna panel switching associated with the one or more of the serving TRP or the serving RRH includes provisioning for at least one of one or more reference symbol resources or a time gap.

In a fifth aspect, alone or in combination with one or more of the first through fourth aspects, the data marker is a passive tag or an active tag.

In a sixth aspect, alone or in combination with one or more of the first through fifth aspects, the one or more SSB parameters are associated with a network node or TRP associated with the transmissive surface.

In a seventh aspect, alone or in combination with one or more of the first through sixth aspects, the one or more SSB parameters include one or more of an SSB index, an SSB periodicity, or an SSB repetition factor.

In an eighth aspect, alone or in combination with one or more of the first through seventh aspects, the SSB beam information includes one or more of a pointing angle of an SSB beam, a field of view of the SSB beam, a coverage footprint of the SSB beam, a width of the SSB beam, or a tilt of the SSB beam.

In a ninth aspect, alone or in combination with one or more of the first through eighth aspects, the transmissive surface information includes an RSRP offset associated with one or more network nodes or TRPs.

In a tenth aspect, alone or in combination with one or more of the first through ninth aspects, the transmissive surface information includes one or more cell identifiers.

In an eleventh aspect, alone or in combination with one or more of the first through tenth aspects, process 800 includes transmitting an access indication associated with reception of the transmissive surface information.

In a twelfth aspect, alone or in combination with one or more of the first through eleventh aspects, process 800 includes receiving a configuration for receiving the transmissive surface information.

In a thirteenth aspect, alone or in combination with one or more of the first through twelfth aspects, process 800 includes detecting one or more of a location or an orientation relative to the data marker.

In a fourteenth aspect, alone or in combination with one or more of the first through thirteenth aspects, receiving the transmissive surface information via the data marker includes accessing, via a URL embedded in the data marker, a database that includes the transmissive surface information.

In a fifteenth aspect, alone or in combination with one or more of the first through fourteenth aspects, the URL embedded in the data marker is encrypted.

In a sixteenth aspect, alone or in combination with one or more of the first through fifteenth aspects, receiving the transmissive surface information via the data marker includes optically scanning the data marker.

In a seventeenth aspect, alone or in combination with one or more of the first through sixteenth aspects, receiving the transmissive surface information via the data marker includes receiving a wireless signal output by the data marker.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a network node or an apparatus of a network node, in accordance with the present disclosure. Example process 900 is an example where the apparatus or the network node (e.g., network node 110) performs operations associated with transmissive surface identification.

As shown in FIG. 9, in some aspects, process 900 may include outputting, for a UE, a downlink signal via a transmissive surface associated with transmissive surface information available via a data marker (block 910). For example, the network node (e.g., using transmission component 1104 and/or communication manager 1106, depicted in FIG. 11) may output, for a UE, a downlink signal via a transmissive surface associated with transmissive surface information available via a data marker, as described above.

As further shown in FIG. 9, in some aspects, process 900 may include receiving, from the UE, a measurement report associated with the downlink signal (block 920). For example, the network node (e.g., using reception component 1102 and/or communication manager 1106, depicted in FIG. 11) may receive, from the UE, a measurement report associated with the downlink signal, as described above.

As further shown in FIG. 9, in some aspects, process 900 may include updating the transmissive surface information in accordance with the measurement report, wherein the transmissive surface information includes one or more of: a transmissive surface location, attribute information associated with the transmissive surface, one or more SSB parameters, or SSB beam information (block 930). For example, the network node (e.g., using communication manager 1106, depicted in FIG. 11) may update the transmissive surface information in accordance with the measurement report, wherein the transmissive surface information includes one or more of: a transmissive surface location, attribute information associated with the transmissive surface, one or more SSB parameters, or SSB beam information, as described above.

Process 900 may include additional aspects, such as any single aspect or any combination of aspects described below and/or in connection with one or more other processes described elsewhere herein.

In a first aspect, updating the transmissive surface information includes updating a database that includes the transmissive surface information.

In a second aspect, alone or in combination with the first aspect, the attribute information associated with the transmissive surface includes one or more of a dimension span, a curvature, a field of view, a reference point location, a data marker location, an effective gain parameter, an attenuation parameter, a geometric shape, or a color.

In a third aspect, alone or in combination with one or more of the first and second aspects, process 900 includes receiving an antenna panel orientation relative to the transmissive surface, wherein the antenna panel orientation is associated with the UE.

In a fourth aspect, alone or in combination with one or more of the first through third aspects, process 900 includes outputting, for the UE, provisioning for antenna panel switching associated with one or more of a serving TRP or a serving RRH.

In a fifth aspect, alone or in combination with one or more of the first through fourth aspects, the provisioning for antenna panel switching associated with the one or more of the serving TRP or the serving RRH includes provisioning for at least one of one or more reference symbol resources or a time gap.

In a sixth aspect, alone or in combination with one or more of the first through fifth aspects, the one or more SSB parameters include one or more of an SSB index, an SSB periodicity, or an SSB repetition factor.

In a seventh aspect, alone or in combination with one or more of the first through sixth aspects, the SSB beam information includes one or more of a pointing angle of an SSB beam, a field of view of the SSB beam, a coverage footprint of the SSB beam, a width of the SSB beam, or a tilt of the SSB beam.

In an eighth aspect, alone or in combination with one or more of the first through seventh aspects, the transmissive surface information includes an RSRP offset.

In a ninth aspect, alone or in combination with one or more of the first through eighth aspects, the transmissive surface information includes one or more cell identifiers.

In a tenth aspect, alone or in combination with one or more of the first through ninth aspects, process 900 includes receiving an access indication associated with reception, by the UE, of the transmissive surface information.

In an eleventh aspect, alone or in combination with one or more of the first through tenth aspects, process 900 includes outputting, for the UE, a configuration for receiving the transmissive surface information.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 150 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 140 described in connection with FIG. 1) of the UE.

In some aspects, the apparatus 1000 may be configured to perform one or more operations described herein in connection with FIGS. 3-7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the UE described above in connection with FIG. 1, such as a radio, one or more RF chains, one or more transceivers, or one or more modems, each of which may in turn be coupled with one or more antennas of the UE.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1004 may be co-located with the reception component 1002.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive transmissive surface information via a data marker. The reception component 1002 may receive a downlink signal via a transmissive surface associated with the transmissive surface information. The transmission component 1004 may transmit a measurement report associated with the downlink signal received via the transmissive surface, wherein the transmissive surface information includes one or more of: a transmissive surface location, attribute information associated with the transmissive surface, one or more SSB parameters, or SSB beam information. The transmission component 1004 may transmit an antenna panel orientation relative to the transmissive surface. The reception component 1002 may receive provisioning for antenna panel switching associated with one or more of a serving TRP or a serving RRH. The transmission component 1004 may transmit an access indication associated with reception of the transmissive surface information. The reception component 1002 may receive a configuration for receiving the transmissive surface information. The communication manager 1006 may detect one or more of a location or an orientation relative to the data marker.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 155 described in connection with FIG. 1. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 145 described in connection with FIG. 1) of the network node.

In some aspects, the apparatus 1100 may be configured to perform one or more operations described herein in connection with FIGS. 3-7. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the network node described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the network node described above in connection with FIG. 1, such as a radio, one or more RF chains, one or more transceivers, or one or more modems, each of which may in turn be coupled with one or more antennas of the network node. In some aspects, the reception component 1102 and/or the transmission component 1104 may include or may be included in a network interface. The network interface may be configured to obtain and/or output signals for the apparatus 1100 via one or more communications links, such as a backhaul link, a midhaul link, and/or a fronthaul link.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1104 may be co-located with the reception component 1102.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The transmission component 1104 may output, for a UE, a downlink signal via a transmissive surface associated with transmissive surface information available via a data marker. The reception component 1102 may receive, from the UE, a measurement report associated with the downlink signal. The communication manager 1106 may update the transmissive surface information in accordance with the measurement report, wherein the transmissive surface information includes one or more of: a transmissive surface location, attribute information associated with the transmissive surface, one or more SSB parameters, or SSB beam information. The reception component 1102 may receive an antenna panel orientation relative to the transmissive surface, wherein the antenna panel orientation is associated with the UE. The transmission component 1104 may output, for the UE, provisioning for antenna panel switching associated with one or more of a serving TRP or a serving RRH. The reception component 1102 may receive an access indication associated with reception of the transmissive surface information. The transmission component 1104 may output, for the UE, a configuration for receiving the transmissive surface information.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

### Aspect 1

A method of wireless communication performed by a UE, comprising: receiving transmissive surface information via a data marker; receiving a downlink signal via a transmissive surface associated with the transmissive surface information; and transmitting a measurement report associated with the downlink signal received via the transmissive surface, wherein the transmissive surface information includes one or more of: a transmissive surface location, attribute information associated with the transmissive surface, one or more SSB parameters, or SSB beam information.

### Aspect 2

The method of Aspect 1, wherein the attribute information associated with the transmissive surface includes one or more of a dimension span, a curvature, a field of view, a reference point location, a data marker location, an effective gain parameter, an attenuation parameter, a geometric shape, or a color.

### Aspect 3

The method of any of Aspects 1-2, further comprising transmitting an antenna panel orientation relative to the transmissive surface.

### Aspect 4

The method of any of Aspects 1-3, further comprising receiving provisioning for antenna panel switching associated with one or more of a serving TRP or a serving RRH.

### Aspect 5

The method of Aspect 4, wherein the provisioning for antenna panel switching associated with the one or more of the serving TRP or the serving RRH includes provisioning for at least one of one or more reference symbol resources or a time gap.

### Aspect 6

The method of any of Aspects 1-5, wherein the data marker is a passive tag or an active tag.

### Aspect 7

The method of any of Aspects 1-6, wherein the one or more SSB parameters are associated with a network node or TRP associated with the transmissive surface.

### Aspect 8

The method of any of Aspects 1-7, wherein the one or more SSB parameters include one or more of an SSB index, an SSB periodicity, or an SSB repetition factor.

### Aspect 9

The method of any of Aspects 1-8, wherein the SSB beam information includes one or more of a pointing angle of an SSB beam, a field of view of the SSB beam, a coverage footprint of the SSB beam, a width of the SSB beam, or a tilt of the SSB beam.

### Aspect 10

The method of any of Aspects 1-9, wherein the transmissive surface information includes an RSRP offset associated with one or more network nodes or TRPs.

### Aspect 11

The method of any of Aspects 1-10, wherein the transmissive surface information includes one or more cell identifiers.

### Aspect 12

The method of any of Aspects 1-11, further comprising transmitting an access indication associated with reception of the transmissive surface information.

### Aspect 13

The method of any of Aspects 1-12, further comprising receiving a configuration for receiving the transmissive surface information.

### Aspect 14

The method of any of Aspects 1-13, further comprising detecting one or more of a location or an orientation relative to the data marker.

### Aspect 15

The method of any of Aspects 1-14, wherein receiving the transmissive surface information via the data marker includes accessing, via a URL embedded in the data marker, a database that includes the transmissive surface information.

### Aspect 16

The method of Aspect 15, wherein the URL embedded in the data marker is encrypted.

### Aspect 17

The method of any of Aspects 1-16, wherein receiving the transmissive surface information via the data marker includes optically scanning the data marker.

### Aspect 18

The method of any of Aspects 1-17, wherein receiving the transmissive surface information via the data marker includes receiving a wireless signal output by the data marker.

### Aspect 19

A method of wireless communication performed by a network node, comprising: outputting, for a UE, a downlink signal via a transmissive surface associated with transmissive surface information available via a data marker; receiving, from the UE, a measurement report associated with the downlink signal; and updating the transmissive surface information in accordance with the measurement report, wherein the transmissive surface information includes one or more of: a transmissive surface location, attribute information associated with the transmissive surface, one or more SSB parameters, or SSB beam information.

### Aspect 20

The method of Aspect 19, wherein updating the transmissive surface information includes updating a database that includes the transmissive surface information.

### Aspect 21

The method of any of Aspects 19-20, wherein the attribute information associated with the transmissive surface includes one or more of a dimension span, a curvature, a field of view, a reference point location, a data marker location, an effective gain parameter, an attenuation parameter, a geometric shape, or a color.

### Aspect 22

The method of any of Aspects 19-21, further comprising receiving an antenna panel orientation relative to the transmissive surface, wherein the antenna panel orientation is associated with the UE.

### Aspect 23

The method of any of Aspects 19-22, further comprising outputting, for the UE, provisioning for antenna panel switching associated with one or more of a serving TRP or a serving RRH.

### Aspect 24

The method of Aspect 23, wherein the provisioning for antenna panel switching associated with the one or more of the serving TRP or the serving RRH includes provisioning for at least one of one or more reference symbol resources or a time gap.

### Aspect 25

The method of any of Aspects 19-24, wherein the one or more SSB parameters include one or more of an SSB index, an SSB periodicity, or an SSB repetition factor.

### Aspect 26

The method of any of Aspects 19-25, wherein the SSB beam information includes one or more of a pointing angle of an SSB beam, a field of view of the SSB beam, a coverage footprint of the SSB beam, a width of the SSB beam, or a tilt of the SSB beam.

### Aspect 27

The method of any of Aspects 19-26, wherein the transmissive surface information includes an RSRP offset.

### Aspect 28

The method of any of Aspects 19-27, wherein the transmissive surface information includes one or more cell identifiers.

### Aspect 29

The method of any of Aspects 19-28, further comprising receiving an access indication associated with reception, by the UE, of the transmissive surface information.

### Aspect 30

The method of any of Aspects 19-29, further comprising outputting, for the UE, a configuration for receiving the transmissive surface information.

### Aspect 31

An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-30.

### Aspect 32

An apparatus for wireless communication at a device, the apparatus comprising one or more memories and one or more processors coupled to the one or more memories, the one or more processors configured to cause the device to perform the method of one or more of Aspects 1-30.

### Aspect 33

An apparatus for wireless communication, the apparatus comprising at least one means for performing the method of one or more of Aspects 1-30.

### Aspect 34

A non-transitory computer-readable medium storing code for wireless communication, the code comprising instructions executable by one or more processors to perform the method of one or more of Aspects 1-30.

### Aspect 35

A non-transitory computer-readable medium storing a set of instructions for wireless communication, the set of instructions comprising one or more instructions that, when executed by one or more processors of a device, cause the device to perform the method of one or more of Aspects 1-30.

### Aspect 36

A device for wireless communication, the device comprising a processing system that includes one or more processors and one or more memories coupled with the one or more processors, the processing system configured to cause the device to perform the method of one or more of Aspects 1-30.

### Aspect 37

An apparatus for wireless communication at a device, the apparatus comprising one or more memories and one or more processors coupled to the one or more memories, the one or more processors individually or collectively configured to cause the device to perform the method of one or more of Aspects 1-30.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
receive transmissive surface information via a data marker;
receive a downlink signal via a transmissive surface associated with the transmissive surface information; and
transmit a measurement report associated with the downlink signal received via the transmissive surface,
wherein the transmissive surface information includes one or more of:
a transmissive surface location,
attribute information associated with the transmissive surface,
one or more synchronization signal block (SSB) parameters, or SSB beam information.

2. The UE of claim 1, wherein the attribute information associated with the transmissive surface includes one or more of a dimension span, a curvature, a field of view, a reference point location, a data marker location, an effective gain parameter, an attenuation parameter, a geometric shape, or a color.

3. The UE of claim 1, wherein the one or more processors are further configured to cause the UE to transmit an antenna panel orientation relative to the transmissive surface.

4. The UE of claim 1, wherein the one or more processors are further configured to cause the UE to receive provisioning for antenna panel switching associated with one or more of a serving transmission reception point (TRP) or a serving remote radio head (RRH).

5. The UE of claim 4, wherein the provisioning for antenna panel switching associated with the one or more of the serving TRP or the serving RRH includes provisioning for at least one of one or more reference symbol resources or a time gap.

6. The UE of claim 1, wherein the data marker is a passive tag or an active tag.

7. The UE of claim 1, wherein the one or more SSB parameters are associated with a network node or transmission reception point associated with the transmissive surface.

8. The UE of claim 1, wherein the one or more SSB parameters include one or more of an SSB index, an SSB periodicity, or an SSB repetition factor.

9. The UE of claim 1, wherein the SSB beam information includes one or more of a pointing angle of an SSB beam, a field of view of the SSB beam, a coverage footprint of the SSB beam, a width of the SSB beam, or a tilt of the SSB beam.

10. The UE of claim 1, wherein the transmissive surface information includes a reference signal received power (RSRP) offset associated with one or more network nodes or transmission reception points.

11. The UE of claim 1, wherein the transmissive surface information includes one or more cell identifiers.

12. The UE of claim 1, wherein the one or more processors are further configured to cause the UE to transmit an access indication associated with reception of the transmissive surface information.

13. The UE of claim 1, wherein the one or more processors are further configured to cause the UE to receive a configuration for receiving the transmissive surface information.

14. The UE of claim 1, wherein the one or more processors are further configured to cause the UE to detect one or more of a location or an orientation relative to the data marker.

15. The UE of claim 1, wherein the one or more processors, to cause the UE to receive the transmissive surface information via the data marker, are configured to cause the UE to access, via a uniform resource locator (URL) embedded in the data marker, a database that includes the transmissive surface information.

16. The UE of claim 15, wherein the URL embedded in the data marker is encrypted.

17. The UE of claim 1, wherein the one or more processors, to cause the UE to receive the transmissive surface information via the data marker, are configured to cause the UE to optically scan the data marker.

18. The UE of claim 1, wherein the one or more processors, to cause the UE to receive the transmissive surface information via the data marker, are configured to cause the UE to receive a wireless signal output by the data marker.

19. A method of wireless communication performed by a user equipment (UE), comprising:
receiving transmissive surface information via a data marker;
receiving a downlink signal via a transmissive surface associated with the transmissive surface information; and
transmitting a measurement report associated with the downlink signal received via the transmissive surface,
wherein the transmissive surface information includes one or more of:
a transmissive surface location,
attribute information associated with the transmissive surface,
one or more synchronization signal block (SSB) parameters, or SSB beam information.

20. An apparatus for wireless communication, comprising:
means for receiving transmissive surface information via a data marker;
means for receiving a downlink signal via a transmissive surface associated with the transmissive surface information; and
means for transmitting a measurement report associated with the downlink signal received via the transmissive surface,
wherein the transmissive surface information includes one or more of:
a transmissive surface location,
attribute information associated with the transmissive surface,
one or more synchronization signal block (SSB) parameters, or SSB beam information.
